(19) United States
(12) Patent Application Publication
(10) Pub. No.: US 2019/0172024 A1
(43) Pub. Date: Jun. 6, 2019

(54) System and Method For Decentralized Digital Currency Issuance, Secure Transfer and De-Issuance

(71) Applicant: Jon Underwood, Portland, OR (US)

(72) Inventor: Jon Underwood, Portland, OR (US)

(21) Appl. No.: 16/211,701

(22) Filed: Dec. 6, 2018

Related U.S. Application Data
(60) Provisional application No. 62/595,187, filed on Dec. 6, 2017.

(51) Int. Cl. G06Q 20/06; G06Q 20/36; G06Q 40/02; G06Q 20/40

(52) U.S. Cl. CPC G06Q 20/065; G06Q 20/401; G06Q 40/02; G06Q 20/36

(57) ABSTRACT

A system and method for decentralized digital currency issuance, secure transfer and de-issuance. The system delivers instant nonreversible delivery of digital currency (such as an eDollar), a cryptographically signed receipt or proxy for a dollar on deposit in a Financial Institution, Insurance Company, a Financial Services Company or under the purview or control an Investment Manager.

### CROSS REFERENCE TO RELATED APPLICATIONS

This applications claims the benefit of U.S. Provisional 62/595,187, filed Dec. 6, 2017, the entirety of which is incorporated by reference.

### BACKGROUND OF THE INVENTION

The present invention is in the technical field of digital currency. More particularly, the present invention is in the technical field of decentralized digital currency issuance, secure transfer and de-issuance.

Conventional payment issuance systems utilize credit and debit cards. These conventional systems rely primarily on Automated Clearing House transfer of funds from one account to the other to settle payments, which is slow and transactions can be reversed.

Digital currencies have emerged as a recent alternative to these conventional payment issuance systems. A digital currency is a type of digital money which is issued and usually controlled by its developers, and used and accepted among the consumers of a specific virtual community. Most digital currencies are crypto currencies, for example Bitcoin.

However, digital-currencies have inherently unstable prices, and are inefficient for use as everyday purchase money. Most digital currencies have a set amount or total supply, and these ‘coins’ are freely traded on exchanges with a free-floating price.

What is needed is digital currency that is expandable and contractible based on user demand, and system maintains a stable price of the digital currency, equivalent to the USD or the underlying national currency or other real world asset, such as gold, thus eliminating risk associated with fluctuating valuations of digital assets.

### SUMMARY OF THE INVENTION

The present disclosure is a system and method for decentralized digital currency issuance, secure transfer and de-issuance. The system delivers instant nonreversible delivery of digital currency. In one embodiment, this digital currency is eDollars®, a cryptographically signed receipt or proxy for a dollar on deposit in a Financial Institution, or under the purview of an Insurance Company, Financial Services Company or Investment Manager.

It can be appreciated that this method gives the owner of the digital currency control over the digital currency, without necessarily owning or controlling the deposit, and that end user may not even have an account at a financial institution. In a further embodiment, the system allows for the digital currency be issued on demand, whenever the consumer, merchant, nonprofit or financial institution wants to, with no centralized authority deciding on whether the user is allowed to issue the digital currency or not. The present disclosure thus delivers to users faster, more secure and less expensive real-time payments and digital asset transfer.

In a further embodiment, anytime users would prefer to use digital currency in a transaction, the system allows them to instantly issue eDollars or e-currencies as they see fit. Furthermore, anytime members who are approved to de-issue eDollars or e-currencies wish to convert into a USD or bank deposit, they can choose to do so as they see fit, without any central authority stopping them, or determining the supply. The system maintains a stable price of the digital currency, equivalent to the USD or the underlying national currency, eliminating risk associated with fluctuating valuations of digital assets.

In a further embodiment, a Dual Payment System enables consumers to register their existing debit cards or checking accounts, and then use the system to quickly and easily complete in-store, online or delivery payments, including for cash intensive or high risk industries. Merchants can only send payment requests, and members always authorize transactions on their phone, eliminating the sources of most transaction fraud.

The system also allows the digital currency to be de-issued, with the digital currency being destroyed and the underlying funds being credited or deposited instantly back into a bank account whenever the owner of the digital currency decides.

### BRIEF DESCRIPTION OF THE DRAWING

These and other objects, features and characteristics of the present embodiments will become more apparent to those skilled in the art from a study of the following detailed description in conjunction with the appended claims and drawings, all of which form a part of this specification. In the drawings:

FIG. 1 is a flowchart of a process for utilizing digital currency according to an embodiment of the present disclosure.

FIG. 2 is a flow-diagram of steps of a method according to an embodiment of the present disclosure.

FIG. 3 is a system architecture according to an embodiment of the present disclosure.

### DETAILED DESCRIPTION OF THE INVENTION

In this description, references to an “embodiment” mean that the particular element, function, structure or feature being described is included in at least one embodiment of the system introduced here. Uses of this phrase in this disclosure do not necessarily all refer to the same embodiment. On the other hand, the embodiments described are not necessarily mutually exclusive.

Introduced here is a system directed to tools, interfaces, and architectures for providing digital currency related services (“the system”). The end user interface for providing digital currency related services (hereinafter referred to as “Seedpay application”) can be implemented in a number of configurations, e.g., as an online application that can be accessed from an end user browser via a communication network such as the Internet, or an application that can be downloaded to and executed on user devices. The user devices can include devices such as a desktop computer; mobile devices such as a mobile phone, a smartphone, a tablet, a laptop; or other computing devices that are capable of executing mobile applications. Further, the Seedpay application can be accessed on various operating systems, including iOS, Mac, Android, and Windows. The system may utilize a Web Application, Mobile Applications and Blockchain (such as Ethereum blockchain) technology to deliver this solution, or additional technologies may be used in the future to continue to deliver eDollars.

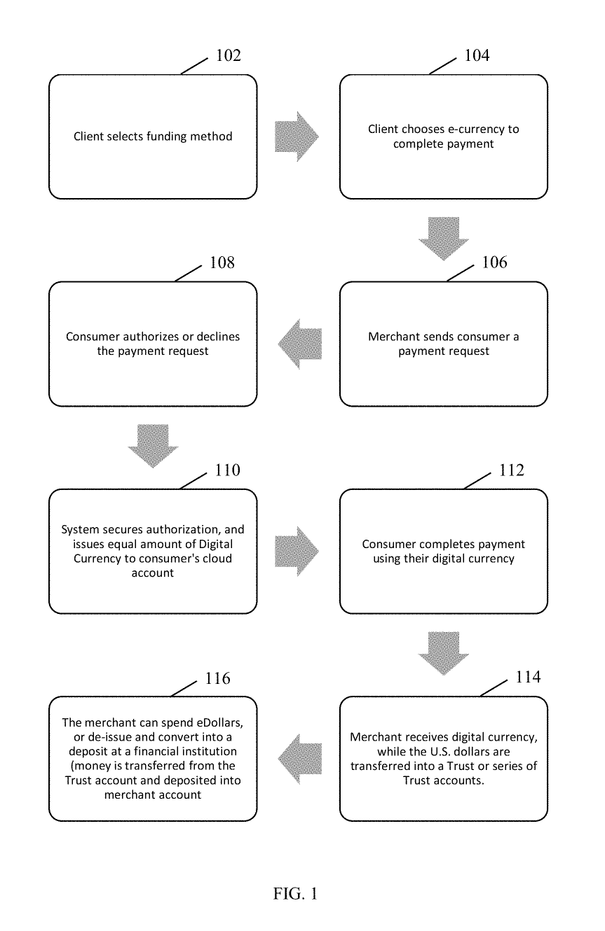

FIG. 1 is a flowchart of a process for utilizing digital currency transactions in a situation where a consumer wishes to pay for an item at a merchant store with e-currency according to an embodiment of the present disclosure. The digital currency can be, for example, an eDollar, a digital USD (which can be represented by a token) that can be securely transferred electronically in real time, nearly instantly.

At step 102, upon a customer registration at a merchant, the consumer selects a funding method, which can be a credit, or debit card, or a checking account, or other liquid or digital assets. It can be appreciated that the customer has access to a wide variety of funding methods. In one embodiment, the registration further comprises a KYC verification.

At step 104, if a consumer wished to pay with an e-currency such as eDollars, they inform the merchant. This can be done through the Seedpay system, wherein consumer informs the merchant they want to pay with ‘Seedpay,’ via a web app, payment terminal, or similar device.

At step 106, the merchant sends the consumer a payment request, and at step 108 the consumer authorizes or declines the payment request using a smartphone notification system. At step 110, the system secures authorization, or a ‘good funds guarantee’, and the system instantly issues an equal amount of Digital Currency and places them in the consumer's cloud account, which they access using the mobile phone. At step 112, the consumer completes payment using their digital currency, and at step 114 the merchant receives digital currency, while the U.S. dollars are transferred into a Bank Account, Trust Account, Insurance Company, Financial Services Company or under the purview of a licensed Investment Manager. This is known as the system “dual payment” system.

The merchant is then able to immediately spend their eDollars, or use them to complete payment. For example, they can spend eDollars with other merchants who are signed up in the system. In a unique feature of the present disclosure, if and when the merchant decides they have excess digital currency, then at step 116 they can instantly de-issue and convert into a deposit at a financial institution, and the money is transferred from the Bank Account, Trust Account, Insurance Company, Financial Services Company or Investment Manager and deposited into their business account, and is available for use or withdrawal in 3-5 minutes, or instantly with a deeper technical integration with the financial institution's core banking software platform.

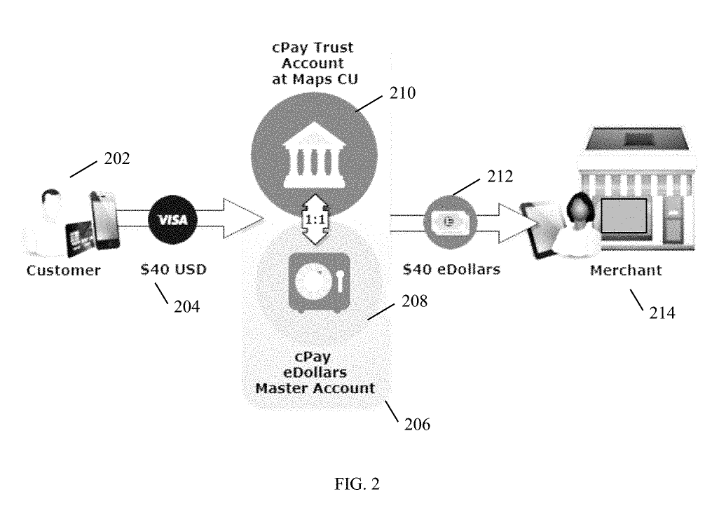

Referring now to the invention in more detail, shown in FIG. 2 is a flow-diagram of steps of a method utilizing the “dual payment method” of the present invention. At step 202, the customer wishes to make a purchase at a point of sale and has elected to pay with e-currency. At step 204, the system charges the customer in regular currency. At step 206, the system secures authorization, or a ‘good funds guarantee’, and the system instantly issues an equal amount of Digital Currency to a Seedpay eDollar master account 208 in 1:1 ratio as that the currency put into the trust account 210. Then at step 212 the merchant 214 is paid in an equivalent amount of eDollars.

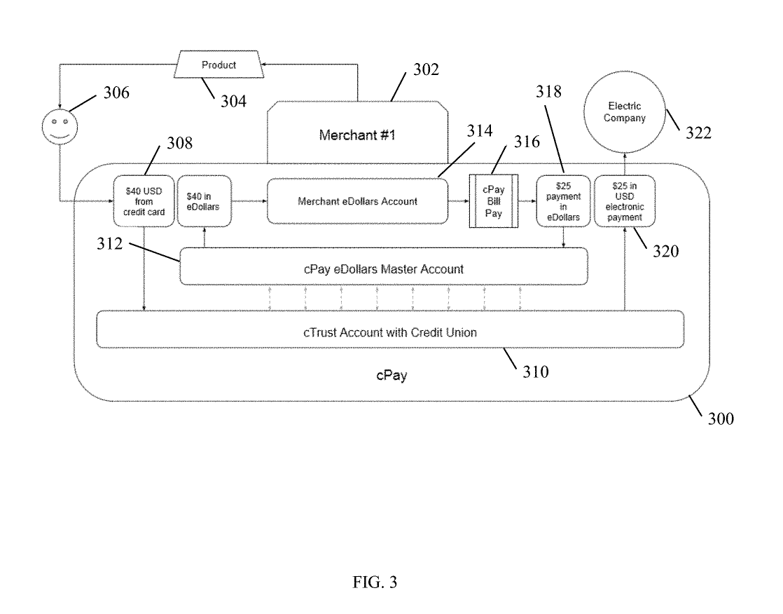

Referring now to FIG. 3 wherein a system architecture according to an embodiment of the present disclosure is shown, the Seedpay system 300 is shown in more detail. A merchant 302 supplies a product 304 to a consumer 306, who is charged $40 USD from credit card 308 which is then deposited into trust account 310. Trust account 310 issues an equivalent amount of eDollars from eDollars Master Account 312, in this case $40 in eDollars, to merchant eDollar account 314. The merchant is able to immediately spend these eDollars, or use them to complete payment. In this example, the merchant desires to pay an electric company $25, so it initiates a request to Seedpay bill pay 316 which will pay back the master account $25 eDollars in block 318. The credit union then issues an equivalent amount of USD in electronic payment 320 to the electric company 322.

It can be appreciated that the digital currency is built on a system blockchain and implanted as an eDollar token. The system blockchain eliminates currency risk and creates a complete chain of custody by maintaining a complete history of every eDollar token. In a further embodiment, eDollars are only created by approved vendors in order to complete a transaction for an exchange of goods and services. In one embodiment, the system maintains a KYC Complaint Chain-of-Custody. In a further embodiment, the system implements a real-time machine learning compliance engine that reviews and maintains appropriate oversight on all of system merchants, with changes in status being reported daily.

The various participants and elements described herein may operate one or more computer apparatuses to facilitate the functions described herein. Any of the elements in the figures, including any servers or databases, may use any suitable number of subsystems to facilitate the functions described herein.

Specific details regarding some of the above-described aspects are provided above. The specific details of the specific aspects may be combined in any suitable manner without departing from the spirit and scope of embodiments of the technology. For example, back end processing, data analysis, data collection, and other transactions may all be combined in some embodiments of the technology. However, other embodiments of the technology may be directed to specific embodiments relating to each individual aspect, or specific combinations of these individual aspects.

It should be understood that the present technology as described above can be implemented in the form of control logic using computer software (stored in a tangible physical medium) in a modular or integrated manner. While the present invention has been described using a particular combination of hardware and software in the form of control logic and programming code and instructions, it should be recognized that other combinations of hardware and software are also within the scope of the present invention. Based on the disclosure and teachings provided herein, a person of ordinary skill in the art will know and appreciate other ways and/or methods to implement the present technology using hardware and a combination of hardware and software

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the technology will become apparent to those skilled in the art upon review of the disclosure. The scope of the technology should, therefore, be determined not with reference to the above description, but instead should be determined with reference to the pending claims along with their full scope or equivalents.

In some embodiments, any of the entities described herein may be embodied by a computer that performs any or all of the functions and steps disclosed.

One or more features from any embodiment may be combined with one or more features of any other embodiment without departing from the scope of the technology.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

1. A method for implementing a cryptocurrency transfer out of a digital wallet as part of a Dual Payment system, comprising:
establishing, by a payment terminal of a merchant, a funding method by a consumer;
sending the consumer a payment request;
authorizing, by the consumer, the payment request;
securing authorization of a good funds guarantee and receiving a currency payment from the consumer, and issuing digital currency to a cloud account of the consumer once the authorization is secured;
completing the payment using the digital currency, wherein completing the payment further comprises sending the digital currency to a cloud account of the merchant and transferring the currency payment to a trust or bank account.

2. The method of claim 1, further comprising causing transfer out of the trust or bank account at a merchant's request into a deposit at a financial instituting and charging the cloud account of the counter-party an equivalent amount of digital currency.

3. The method of claim 2, wherein the funding method is a credit, or debit card, or a checking account.

4. The method of claim 3, wherein the digital currency further comprises a stable token cryptocurrency tied to a national currency or real world asset or digital asset.

5. The method of claim 4, wherein the consumer authorizes the payment request via a smartphone notification system.

6. The method of claim 5, wherein the digital currency issued to the cloud account of the consumer is equivalent to the amount of the good funds guarantee.

7. The method of claim 1, further comprising accepting a request from the merchant to pay a third party and then causing transfer out of the trust account at a merchant's request into a third party merchant and charging the cloud account of the merchant an equivalent amount of digital currency.

8. The method of claim 1, wherein the digital currency is only created by approved vendors in order to complete a transaction for an exchange of goods and services.

9. A system comprising:
a memory operable to:
establish, by a payment terminal of a merchant, a funding method by a consumer;
send the consumer a payment request;
authorize, by the consumer, the payment request;
secure authorization of a good funds guarantee and receive a currency payment from the consumer, and issue digital currency to a cloud account of the consumer once the authorization is secured;
complete the payment using the digital currency, wherein completing the payment further comprises sending the digital currency to a cloud account of the merchant and transferring the currency payment to a trust account.

10. The system of claim 9, the memory further including executable instructions that upon execution cause the system to: transfer out of the trust or bank account at a merchant's request into a deposit at a financial instituting and charging the cloud account of the counter-party an equivalent amount of digital currency.

11. The system of claim 10, wherein the funding method is a credit, or debit card, or a checking account.

12. The system of claim 11, wherein the digital currency further comprises a stable token cryptocurrency tied to a national currency or real world or digital asset.

13. The system of claim 12, wherein the consumer authorizes the payment request via a smartphone notification system.

14. The system of claim 13, wherein the digital currency issued to the cloud account of the consumer is equivalent to the amount of the good funds guarantee.

15. The system of claim 14, the memory further including executable instructions that upon execution cause the system to: accept a request from the merchant to pay a third party and then transfer out of the trust or bank account at a merchant's request into a third party merchant and charge the cloud account of the merchant an equivalent amount of digital currency.

16. The system of claim 15, wherein the digital currency is only created by approved vendors in order to complete a transaction for an exchange of goods and services.

17. A server comprising:
a memory operable to:
establish, by a payment terminal of a merchant, a funding method by a consumer;
send the consumer a payment request;
authorize, by the consumer, the payment request;
secure authorization of a good funds guarantee and receive a currency payment from the consumer, and issue digital currency to a cloud account of the consumer once the authorization is secured;
complete the payment using the digital currency, wherein completing the payment further comprises sending the digital currency to a cloud account of the merchant and transferring the currency payment to a trust account.

18. The server of claim 17, the memory further including executable instructions that upon execution cause the system to: transfer out of the trust account at a merchant's request into a deposit at a financial instituting and charging the cloud account of the counter-party an equivalent amount of digital currency.

19. The server of claim 18, wherein the funding method is a credit, or debit card, or a checking account.

20. The server of claim 19, the memory further including executable instructions that upon execution cause the system to: accept a request from the merchant to pay a third party and then transfer out of the trust or bank account at a merchant's request into a third party merchant and charge the cloud account of the merchant an equivalent amount of digital currency.
